(19) United States
(12) Patent Application Publication
(10) Pub. No.: US 2023/0404165 A1
(43) Pub. Date: Dec. 21, 2023

(54) PUFFING SESSION END NOTIFICATION

(71) Applicant: PHILIP MORRIS PRODUCTS S.A., Neuchâtel (CH)

(72) Inventor: Gregory André Cristian, Saint-Sulpice (CH)

(21) Appl. No.: 18/029,810

(22) PCT Filed: Oct. 5, 2021
(86) PCT No.: PCT/IB2021/059099

§ 371 Date: Mar. 31, 2023

(30) Foreign Application Priority Data
Oct. 6, 2020 (EP) 20200363.8

(51) Int. Cl. A24F 40/53; A24F 40/60; A24F 40/65

(52) U.S. Cl. CPC A24F 40/53; A24F 40/65; A24F 40/60

(57) ABSTRACT

Aerosol-generating device (102) including a puffing session indicator (127) and a controller (128) operably coupled to the puffing session indicator, the controller configured to monitor a puffing session of a user, determine an end of the puffing session based the monitoring, and provide a puffing session end notification to the user indicative of the end of the puffing session in response to determination of the end of the puffing session.

This invention relates to devices, computer program products, and methods for use in notifying users of the end of puffing sessions. Users may begin puffing sessions, which are monitored to determine the end of the puffing sessions, and the users are notified of the end of their puffing sessions.

Smokers, or users, of conventional, combustion-style, cigarettes have clear start and stop experiences to puffing sessions. For instance, the start of a puffing session of a conventional cigarette may be indicated by the removal of the cigarette from a pack, the unlit or un-combusted condition of the cigarette, the full length of the cigarette, the full mass of the cigarette, the sturdy, partially-rigid feel of the cigarette, and the smell of an un-combusted cigarette. In other words, users of conventional, combustion-style, cigarettes have many signs, or signals, some more obvious than others to indicate that a puffing session is about to start or begin.

Further, the end of a puffing session of a conventional cigarette may be indicated by the partially-combusted condition of the cigarette, the shortened length of the cigarette, the lessened mass of the cigarette, the less sturdy or rigid feel of the cigarette, and the smell of a partially combusted cigarette. In other words, users of conventional, combustion-style, cigarettes have many signs, or signals, some more obvious than others, to indicate that a puffing session is about to end or cease.

Smokers, or users, of conventional, combustion-style, cigarettes may utilize many of their senses to determine the start and ending of a puffing session using such aforementioned signs or signals indicative of the start or end of puffing session. For example, users may utilize their visual sense to determine the physical condition of the cigarette such as the partially combusted or not combusted condition of the cigarette and the length of the cigarette. Further, for example, users may utilize their olfactory sense to determine whether the cigarette is partially combusted or not combusted. Still further, for example, users may utilize their somatosensory sense to determine whether the cigarette is less sturdy or rigid. It is be understood that other signs, or signals, that indicate the start and end of a puffing session described herein are not exhaustive, and that other signs, or signals, are available to smokers.

Since smokers of conventional, combustion-style, cigarettes have clear start and stop experiences to puffing sessions, such smokers may learn when to end their puffing session based on such stop experiences as well as the duration from the start experiences. As a result, smokers of conventional cigarettes are provided breaks between puffing sessions that are indicated by the such start and stop experiences. In turn, smokers of conventional cigarettes may be “informed” of their consumption based on an amount of puffing sessions.

In contrast, users of aerosol-generating devices that generate aerosol without combustion from, for example, an article that includes a tobacco substrate (for example, heat-not-burn style aerosol-generating devices) may not have such clear start and stop experiences to puffing sessions, which may be sensed by the users. For example, it may not be obvious to users when puffing sessions have started or ended because users may not fully consume the tobacco substrate over the duration of a typical puffing session. Further, the visual, olfactory, and somatosensory indications of the start and end of puffing sessions may be different than those of conventional cigarettes.

As a result, users of aerosol-generating devices that generate aerosol without combustion from, for example, an article that includes a tobacco substrate may feel uncomfortable with puffing session rituals associated therewith and may struggle to adopt the aerosol-generating devices without defined puffing sessions start and stop experiences. Further, users of non-combustion style aerosol-generating devices may keep using the aerosol-generating devices constantly “on” during the day, since the traditional start and stop cues, or experiences, are not present or are simply different than conventional, combustion-style, cigarettes. Still further, without clear start and stop experiences to puffing sessions, users may be lacking insight in consumption (for example, inhalation data and exposure data), and thus, may not be able act accordingly.

PCT Pub. No. WO 2020/006311 describes a vaporizer system that includes a device in communication with a vaporizer that can track usage relative to one or more usage limits set by a user. The usage limit can be a number of puffs over a given period of time. The device may notify the user of progress towards reaching the usage limit on a user interface.

U.S. Pat. No. 10,398,178 B2 describes an electronic vaporizer with a haptic device that converts electrical energy into mechanical energy that is intended to be tactilely sensed, or can be tactilely sensed by the user while the vaporizer is actively producing vapor may be used. Further, the haptic device may not operate during activation of the electronic vaporizer and then vibrate or pulse in intervals to communicate the status of the electronic vaporizer.

U.S. Pat. App. Pub. No. 2019/0069603 describes a personal vapourising device storing a substance to be vapourised, the device including a means of indicating by visual cue, audible cue, touch feedback, haptic, vibration, heat or other sensory signal, or prompt, when the device has sufficiently heated the substance to a predetermined temperature or for a predetermined time, so that the device is ready for use.

U.S. Pat. App. Pub. No. 2016/0338407 describes a programmable controller that contains a haptic interface such that the user can receive tactile feedback on their drag, for example, using a current to stimulate the hand that is holding the vape device, or a buzzer motor, or a notification method to the display, or by lighting a series of lights in sequence depending on the strength and/or length of the inhalation through the vape device.

U.S. Pat. App. Pub. No. 2015/0020825 describes an electronic smoking article adapted to provide haptic feedback to a user. The haptic feedback may define a working status, such as heating of a heater to form an aerosol, powering up of the device, or powering down of the device. Haptic feedback may define a further status of the device, such as a low reservoir level for the aerosol precursor composition, failure of the device to function properly, proper connection of the control component to a cartridge, or the like. In some embodiments, haptic feedback may be independent of device status. For example, the haptic feedback may be provided to enhance the user experience with the device.

It would be desirable for users of aerosol-generating devices that generate aerosol without combustion to have one or both of start and stop experiences to, for example, develop a ritual and inform the users thereof of their aerosol consumption. For instance, stop experiences may restrict users from constantly using aerosol-generating devices during the day. Additionally, stop experiences may provide users insight into their consumption (for example, inhalation data and exposure data). Such insight into consumption may allow users to act accordingly to ensure that their consumption remains “in check” and under control.

According to an aspect of the present invention, there is provided a method for use with an aerosol-generating device comprising monitoring a puffing session of a user using the aerosol-generating device, determining an end of the puffing session based the monitoring, and providing a puffing session end notification to the user indicative of the end of the puffing session in response to determination of the end of the puffing session.

According to another aspect of the present invention, there is provided a computer program product for use with aerosol-generating apparatus comprising a non-transitory computer readable medium having program code stored thereon, the program code configured, when said program product is run on a computer, to monitor a puffing session of a user using the aerosol-generating device, determine an end of the puffing session based the monitoring, and provide a puffing session end notification to the user indicative of the end of the puffing session in response to determination of the end of the puffing session.

According to another aspect of the present invention, there is provided an aerosol-generating apparatus comprising a puffing session indicator and a controller comprising one or more processors and operably coupled to the puffing session indicator. The controller is configured to monitor a puffing session of a user, determine an end of the puffing session based the monitoring, and provide a puffing session end notification to the user indicative of the end of the puffing session in response to determination of the end of the puffing session.

The puffing session includes and extends from the initial puff, or inhalation, of aerosol using an aerosol-generating device to the final puff, or inhalation, of aerosol during such puffing session using the aerosol-generating device. The puffing session could extend over a plurality, or multiple, minutes. A puffing session, however, may be dictated by one or more of an amount of puffing time, a number of puffs taken, or an amount of aerosol generated (and potentially inhaled). Thus, the puffing session may be defined by a selected number of puffs, a selected amount of puffing time, or a selected amount of aerosol generated, among other things.

For example, in one aspect, an amount of puffing time is monitored over a moving, or rolling, time window and the end of the puffing session is determined when the amount of puffing time exceeds a puffing time threshold during the moving time window. Further, for example, in another aspect, a number of puffs is monitored over a moving, or rolling, time window and the end of the puffing session is determined when the number of puffs exceeds a puff number threshold during the moving time window. The moving time window is selected to capture maximum amount of time a user is expected to complete a single puffing session. In one aspect, the moving time window is 30 minutes. In other aspects, the moving time window is shorter than 30 minutes such as, for example, 5 minutes, 10 minutes, 15 minutes or 20 minutes. Further, in other aspects, the moving time window is longer than 30 minutes such as, for example, 40 minutes, 45 minutes, or 1 hour.

It may be described that the moving time window is “moving” or “rolling” in that it is a window that slides along a time line such that any puffs that occur on the time line during the window may be tabulated or summed to provide the amount of puffing time or number of puffs during the moving time window. In this way, the moving time window may accurately capture a puffing session. Additionally, it may be described that the moving time window can be considered to be a backwards looking timeframe that looks back the amount of time, or duration, of the moving time window. In other words, if the moving time window is 30 minutes long, the moving time window may “look back” the last 30 minutes to tabulate or sum the amount of puffing time or number of puffs during the 30 minutes prior to present.

The amount of puffing time is an amount of time that the user puffs, or inhales, aerosol from the aerosol-generating device, which may be tabulated or summed on a continuing basis within or over the moving time window. Likewise, the number of puffs is a number of times that the user puffs, or inhales, aerosol from the aerosol-generating device, which may be tabulated or summed a continuing basis within or over the moving time window. Each of the amount of puffing time and the number of puffs over the moving time window is compared to a threshold value to determine whether the puffing session has been completed (for example, ended or ceased).

The puffing time threshold may be set, or configured, to an amount of puffing time that captures a typical puffing session for a user. For example, a puffing time threshold may be designed to deliver an amount of aerosol that a user expects to receive during a single puffing session. In one aspect, the puffing time threshold is 30 seconds of puffing time. In other aspects, the puffing time threshold is shorter than 30 seconds such as, for example, 25 second, 20 seconds, 15 seconds, 10 seconds, or 5 seconds. Further, in other aspects, the puffing time threshold is longer than 30 seconds such as, for example, 25 seconds or 50 seconds.

The puffing time threshold may be pre-configured at the time of manufacture and also may be selected, or changed, by a user after purchase. Thus, in one aspect, a user is allowed to select the puffing time threshold. For instance, some users may take larger puffs over the same amount of time than a typical user, and thus, may require less puffing time per puffing session. As a result, such larger-puff users may desire to decrease the puffing time threshold used to indicate the end of the puffing session. Likewise, some users may take smaller puffs over the same amount of time than a typical user, and thus, may require more puffing time per puffing session. As a result, such smaller-puff users may desire to increase the puffing time threshold used to indicate the end of the puffing session.

The puff number threshold may also be set, or configured, to a number of puffs that captures a typical puffing session. For example, a puff number threshold may be selected, designed, to deliver an amount of aerosol a user expects to receive during a single session. In one aspect, the puff threshold is 20 puffs. In other aspects, the puff number threshold is shorter than 20 puffs such as, for example, 15 puffs, 10 puffs, or 5 puffs. Further, in other aspects, the puff number threshold is longer than 20 puffs such as, for example, 30 puffs or 40 puffs.

The puff number threshold may be pre-configured at the time of manufacture and also may be selected, or changed, by a user after purchase. Thus, in one aspect, a user is allowed to select the puff number threshold. For instance, some users may take larger puffs (for example, longer puffs) than a typical user, and thus, may require less puffs per puffing session. Aa result, such larger-puff users may desire to decrease the puff number threshold used to indicate the end of the puffing session. Likewise, some users may take smaller puffs (for example, shorter puffs) than a typical user, and thus, may require more puffs per puffing session. As a result, such smaller-puff users may desire to increase the puff number threshold used to indicate the end of the puffing session.

In one aspect, users can select or change the puffing time threshold or puff number threshold using a user interface device such as, for example, a cellular telephone, that is operatively coupled to the aerosol-generating device. For example, the user interface device may be wirelessly operatively coupled, operatively coupled over wired, operatively coupled over a network such as a local network or the Internet, directly operatively coupled via a peer network, or operatively coupled in practically any another other way to the aerosol-generating device so as to be able to communicate puffing time threshold or puff number threshold changes from the user interface device to the aerosol-generating device.

As described herein, an end of the puffing session is determined based the monitoring, which may include one or both of comparing an amount of puffing time over the moving time window to a puffing time threshold or comparing the number of puffs over the moving time window to a puff number threshold. When an end of the puffing session is determined, a puffing session end notification is provided to the user indicative of the end of the puffing session. More specifically, in response to determination of the end of the puffing session, a puffing session end notification is provided to the user indicative of the end of the puffing session.

To do so, the aerosol-generating device includes a puffing session indicator. The puffing session indicator may be any device or apparatus capable of providing a puffing session notification to a user. Further, the puffing session notification can include any type of notification that provides indication or notification to a user that the user is able to sense using one of their senses. In one aspect, the puffing session end notification is a somatosensory output to the user. A somatosensory output may be described as any output that may make a change at the surface or inside the body so as to be felt by a user.

For example, the somatosensory output may be a vibration caused by vibration apparatus located within or as part of the aerosol-generating device. In this way, an end session notification is a vibration of the aerosol-generating device such that the user feels the vibration in their hand (for example, fingers) when their amount of puffing time or number of puffs exceeds the respective thresholds within the moving time window. Thus, a user would be notified of the end of puffing session through the vibration. Additionally, the vibratory somatosensory output may also be described as being haptic feedback to be felt by the user.

In one aspect, to provide such vibratory somatosensory output, the puffing session indicator is a vibrating haptic actuator. One example of a vibrating haptic actuator is an eccentric rotating mass (ERM) motor, such as where an unbalanced weight is rotated around a motor shaft to cause motor displacement that translates into vibration. Most ERM motors advantageously can be powered with direct current. Electromagnetic vibratory motors may be used. An ERM motor can be adapted for simple vibration or may be coupled with a suitable processor driver IC, which can be programmed to vary motor speed to control vibration amplitude and frequency and thus the manner of waveform generated by the smoking article. Another example of a vibrating haptic actuator is a linear resonant actuator (LRA). Such devices typically include an internal magnetic mass and spring, and an electrical current in a voice coil causes the mass to displace. Nonetheless, vibrating haptic actuators, such as ERM motors and LRAs, can be provided in a variety of form factors. For example, the vibrating haptic actuator can be in a cylindrical form factor. In some embodiments, the vibrating haptic actuator can be in a coin form factor (i.e., be substantially shaped like a coin). Further, in some aspects, a vibrating haptic actuator can be adapted to substantially vibrate the entire aerosol-generating device or only a portion thereof. In other words, the vibrating haptic actuator may not be coordinate specific or may be adapted for touch-coordinate specific responses.

Further, for example, the somatosensory output may be a temperature change (for example, heat), pressure change, texture change, or stiffness change of the aerosol-generating device, which may be felt by the user.

In one aspect, the puffing session end notification is turning off, or powering down, the aerosol-generating device. A user will likely immediately notice that that aerosol-generating device is turned or powered off when their amount of puffing time or number of puffs exceeds the respective thresholds within the moving time window. Thus, a user would be notified of the end of puffing session through the turning off of the aerosol-generating device.

In one aspect, the puffing session end notification is a visual output to the user. A visual output may be described as any output that may be seen by a user. For example, the visual output may be provided by one or more visual indicators such as light emitting diodes (LEDs) located on the aerosol-generating device.

In other words, a vaping, or puffing, session profiling feature is described herein that allows a user to setup vaping, or puffing, session thresholds that allow him/her to be notified at the end of each session so that he/she can create a ritual that he/she is familiar with. Further, the puffing session notifications are useful to assist users to understand somehow their consumption. The users may define and set his/her own triggers so that he/she is notified after the user-defined number of puffs or user-defined puffing time have been reached or lapsed. The notification may be delivered at the end of the puff that exceeds the threshold or trigger. In one aspect, the aerosol-generating device will only generate a notification and will not switch off such that the user can continue using the device. It may be described in this circumstance that the notification is for information only.

Furthermore, user can configuration vaping, or puffing, session end notifications and other settings related thereto using a user interface device (for example, a software application, or “app” on the user interface device) that will communicate with the aerosol-generating device. In one aspect, puffing or vaping sessions are defined by a selectable “time of puffing.” In another aspect, puffing or vaping sessions are defined by a selectable “number of puffs.” In one aspect, the notification at the end of puffing sessions experience is intended to be done through device vibration or device turn off, which may be selected or configured by the user.

In one aspect, a user may use a software application on a user interface device and select a “session profiling” feature to “turn on” the session profiling and further select the “time of puffing” that will define his/her puffing session. Once activated, the aerosol-generating device will notify the user at the end of each session, either through device vibration or device turn off. For example, if the user selects 15 seconds per puffing session, he/she will be notified by the device every time he vapes or puffs for 15 seconds.

Additionally, using the software application on a user interface device, the user can select the event which will trigger a notification when reach over a pre-defined, rolling 30 minutes. In this way, a user is able to configure the number of puffs which will trigger the notification. The range supported may be between 1 and 65535 puffs over a rolling period. In one aspect, the rolling time period is 30 minutes. In one aspect, a user may be able to configure or selected the duration of the rolling time period. Further, for example, a user may set the trigger, or threshold, to 20 puffs, the aerosol-generating device will react if 20 puffs are generated over a rolling 30 minutes. In this situation, the puffing time is not relevant and only the number of puffs is used to determine whether the end of a puffing session has been reached.

Alternatively, the user is able to configure the amount of puffing time which will trigger the notification. The range supported may be between 1 and 65535 seconds of puffing time over a rolling period. For example, when setting the trigger, or threshold, to 30 seconds of puffing time, the aerosol-generating device will react when the total amount of puffing time reaches 30 seconds over a rolling time period such as 30 minutes. In this situation, the number of puffs is not relevant and only the puffing time is used.

Furthermore, it is be understood that the illustrative devices, methods, and computer products describes herein are able to inform an user about the necessity of taking a break from inhalation and not only when a puff number reaches to a specific set number but also when a cumulative period of time for puffs over a rolling time period (for example, in the last minutes) is reached. This, even if a user inhales a small number of very long puffs, the device can warn the user.

It is to be understood that the illustrative aerosol-generating devices described herein generate aerosol from articles that include a tobacco substrate that is heated, but not combusted, contain lower amounts or concentrations of certain smoke constituents than smoke or aerosol produced from combustion and pyrolytic degradation of tobacco in conventional cigarettes. In one known type of aerosol-generating device, an aerosol is generated by the transfer of heat from a heat source to a physically separate aerosol-generating article that includes, for example, a substrate containing tobacco. The device is configured such that the heat source does not combust the substrate. During use, volatile compounds are released from the aerosol-generating substrate by heat transfer from the heat source and entrained in air drawn through the aerosol-generating article. As the released compounds cool, they condense to form an aerosol that is inhaled by the user.

The illustrative aerosol-generating devices may define a cavity for receiving the aerosol-generating article and may include a heater configured to heat the aerosol-generating substrate of the article to generate aerosol. The heater may include a blade that is configured to be inserted into an aerosol-generating article to deliver heat to the aerosol-generating substrate of the article. The aerosol-generating devices may include a power supply to at least power the heater and may be configured to be interfaced, or operatively coupled, to a user interface device.

The aerosol-generating device and user interface device may include a controller comprising one or more processors and a communication interface to transfer data to and from each other. Preferably, the aerosol-generating device and the user interface device may communicate using a data coupling (for example, each may include at least one data interface port for communication of data that may be mated to each other) when the aerosol-generating device is received by the host device. Further, for example, a wireless communication interface such as a BLUETOOTH wireless protocol interface may be used between the aerosol-generating device and the user interface device. The controller may include one or more processors (for example, microprocessors) that may operate with associated data storage, or memory, for access to processing programs or routines and one or more types of data that may be employed to carry out the illustrative methods. For example, processing programs or routines stored in data storage may include programs or routines for monitoring a puffing session, maintaining the number of puffs during a moving time period, maintaining the amount of puff time during a moving time period, comparing the number of puffs or amount of puff time to various thresholds, initiating puffing session notifications, statistics, matrix mathematics, compression algorithms (for example, data compression algorithms), standardization algorithms, comparison algorithms, or any other processing used to implement the one or more illustrative methods and processes described herein. Further, for example, processing programs or routines stored in data storage may include processes and functions to transfer data and commands between the aerosol-generating device and user interface device such as puff number threshold changes or puff time changes. The data storage, or memory, may be further configured to store puff number thresholds, puffing time thresholds, a rolling amount of puff time over the moving time period, a rolling number of puffs over the moving time period, related routines, and any other data and/or formulas necessary to perform the processes and methods described herein.

In one or more embodiments, the aerosol-generating device and user interface device may be described as being implemented using one or more computer programs executed on one or more programmable processors that include processing capabilities (for example, microcontrollers, programmable logic devices, etc.), data storage (for example, volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The computer program products used to implement the processes described herein may be provided using any programmable language, for example, a high-level procedural and/or object orientated programming language that is suitable for communicating with a computer system. Any such program products may, for example, be stored on any suitable device, for example, a storage media, readable by a general or special purpose program, controller apparatus for configuring and operating the computer when the suitable device is read for performing the procedures described herein. In other words, at least in one embodiment, the user interface device may be implemented using a non-transitory computer readable storage medium, configured with a computer program, where the storage medium so configured causes the computer to operate in a specific and predefined manner to perform functions described herein.

The exact configuration of the controller of the aerosol-generating device and user interface device is not limiting and essentially any device capable of providing suitable computing capabilities and control capabilities to implement the illustrative methods described herein may be used. In view of the above, it will be readily apparent that the functionality as described in one or more embodiments according to the present invention may be implemented in any manner as would be known to one skilled in the art. As such, the computer language, the controller, or any other software/hardware which is to be used to implement the processes described herein shall not be limiting on the scope of the systems, processes or programs (for example, the functionality provided by such processes or programs) described herein. The methods and processes described in this disclosure, including those attributed to the apparatus, or various constituent components, may be implemented, at least in part, in hardware, software, firmware, or any combination thereof. For example, various aspects of the techniques may be implemented within one or more processors, including one or more microprocessors, DSPs, ASICs, FPGAs, CPLDs, microcontrollers, or any other equivalent integrated or discrete logic circuitry, as well as any combinations of such components. When implemented in software, the functionality ascribed to the systems, devices, and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more aspects of the functionality described in this disclosure.

The term “controller” and “processor” refers to any device or apparatus capable of providing suitable computing capabilities and control capabilities such as, for example, microprocessors, digital signal processors (DSP), application specific integrated circuits (ASIC), field-programmable gate arrays (FPGA), equivalent discrete or integrated logic circuitry, or any combination thereof and of providing suitable data storage capabilities that includes any medium (for example, volatile or non-volatile memory, a CD-ROM, magnetic recordable medium such as a disk or tape, etc.) containing digital bits (for example, encoded in binary, trinary, etc.) that may be readable and/or writeable.

The term “communication interface” refers to any device or apparatus capable of providing suitable data communication capabilities between an aerosol-generating device, a host device, and a user interface device such as, for example, physical data couplings (for example, each may include at least one data interface port for communication of data that may be mated to each other when the aerosol-generating device is received by the host device), various telemetry circuits and antennas and may use one or more wired or wireless (for example, radio frequency) data transmission protocols such as, for example, BLUETOOTH, WI-FI, any protocol in the ultra-high frequency (UHF) band, any protocol in the super high frequency (SHF) band, low frequencies, or combinations thereof.

As described herein, the aerosol-generating device may be further configured to interoperate with a user interface device that is separate from the aerosol-generating device. The user interface device may provide a graphical region (for example, a graphical button) on the graphical user interface that a user may select to change or select the puffing time threshold or the puff number threshold. Upon selection, the user interface device may wirelessly communicate with the aerosol-generating device via a communication interface to send and update the puffing time threshold or the puff number threshold. After the puffing time threshold or the puff number threshold has been updated on the aerosol-generating device, the aerosol-generating device may transmit confirmation data, or information, back to the user interface device to indicate that such thresholds have been successfully updated.

The user interface device may further include a display operatively coupled the controller for the output of data via the display. The display may be further configured to depict and be used as a user interactable, graphical user interface. The graphical user interface and display may comprise a touchscreen. The graphical user interface may be described as being user interactable because the graphical user interface may be configured to allow a user to view and/or manipulate data on the display, to allow a user to interact with user interface device, and the like.

The aerosol-generating apparatus may include an aerosol-generating device and a host device. The term “aerosol-generating device” refers to a device configured to use, or utilize, an aerosol-generating article that releases volatile compounds to form an aerosol that may be inhaled by a user. The term “aerosol-generating article” refers to an article that comprises a substrate capable of releasing, upon heating, volatile compounds, which may form an aerosol. The aerosols generated from aerosol-generating articles according to the invention may be visible or invisible and may include vapours (for example, fine particles of substances, which are in a gaseous state, that are ordinarily liquid or solid at room temperature) as well as gases and liquid droplets of condensed vapours. A “heated-type aerosol-generating article” is an aerosol-generating article that comprises an aerosol-generating substrate and is configured for use with an aerosol-generating device that is configured to heat, but not combust, the aerosol-generating substrate. One example of a heated-type aerosol-generating article are the IQOS heat sticks, also known as MARLBORO HEATSTICKS, from Phillip Morris International for use in an IQOS, heat not burn, aerosol-generating device, also from Phillip Morris International.

The invention is defined in the claims. However, below there is provided a non-exhaustive list of non-limiting examples. Any one or more of the features of these examples may be combined with any one or more features of another example, embodiment, or aspect described herein.

Example Ex1: A method for use with an aerosol-generating device comprising monitoring a puffing session of a user using the aerosol-generating device, determining an end of the puffing session based the monitoring, and providing a puffing session end notification to the user indicative of the end of the puffing session in response to determination of the end of the puffing session.

Example Ex2: Computer program product for use with aerosol-generating apparatus comprising a non-transitory computer readable medium having program code stored thereon, the program code configured, when said program product is run on a computer, to monitor a puffing session of a user using the aerosol-generating device, determine an end of the puffing session based the monitoring, and provide a puffing session end notification to the user indicative of the end of the puffing session in response to determination of the end of the puffing session.

Example Ex3: An aerosol-generating apparatus comprising a puffing session indicator and a controller comprising one or more processors and operably coupled to the puffing session indicator. The controller is configured to monitor a puffing session of a user, determine an end of the puffing session based the monitoring, and provide a puffing session end notification to the user indicative of the end of the puffing session in response to determination of the end of the puffing session.

Example Ex4: The method, computer program product, and aerosol-generating device as in any one of examples Ex1 to Ex3, wherein monitoring a puffing session of a user using the aerosol-generating device comprises monitoring an amount of puffing time over a moving time window and wherein determining the end of the puffing session based the monitoring comprises determining the end of the puffing session when the amount of puffing time exceeds a puffing time threshold during the moving time window.

Example Ex5: The method, computer program product, and aerosol-generating device as in example Ex4, wherein the method further comprises, the program code are further configured to execute, or the controller further configured to execute allowing the user to select the puffing time threshold.

Example Ex6: The method, computer program product, and aerosol-generating device as in any one of examples Ex1 to Ex3, wherein monitoring a puffing session of a user using the aerosol-generating device comprises monitoring a number of puffs over a moving time window and wherein determining the end of the puffing session based the monitoring comprises determining the end of the puffing session when the number of puffs exceeds a puff number threshold during the moving time window.

Example Ex7: The method, computer program product, and aerosol-generating device as in example Ex6, wherein the method further comprises, the program code are further configured to execute, or the controller further configured to execute allowing the user to select the puff number threshold.

Example Ex8: The method, computer program product, and aerosol-generating device as in any one of one of examples Ex4 to Ex7, wherein the moving time window is 30 minutes.

Example Ex9: The method, computer program product, and aerosol-generating device as in any one of examples Ex5 and Ex7, wherein allowing the user to select comprises allowing the user to user a user interface device to select.

Example Ex10: The method, computer program product, and aerosol-generating apparatus as in example Ex9, wherein the user interface device is a cellular telephone.

Example Ex11: The method, computer program product, and aerosol-generating device as in any one of examples Ex1 to Ex9, wherein the puffing session end notification comprises a somatosensory output to the user.

Example Ex12: The method, computer program product, and aerosol-generating apparatus as in example Ex11, wherein the somatosensory output comprises a vibration.

Example Ex13: The method, computer program product, and aerosol-generating device as in any one of examples Ex1 to Ex12, wherein the puffing session end notification comprises turning off the aerosol-generating device.

Reference will now be made to the drawings, which depict one or more aspects described in this disclosure. However, it will be understood that other aspects not depicted in the drawing fall within the scope and spirit of this disclosure. Like numbers used in the figures refer to like components, steps and the like. However, it will be understood that the use of a number to refer to a component in a given figure is not intended to limit the component in another figure labelled with the same number. In addition, the use of different numbers to refer to components in different figures is not intended to indicate that the different numbered components cannot be the same or similar to other numbered components. Further, the schematic drawings are not necessarily to scale and are presented for purposes of illustration and not limitation.

Examples will now be further described with reference to the figures in which:

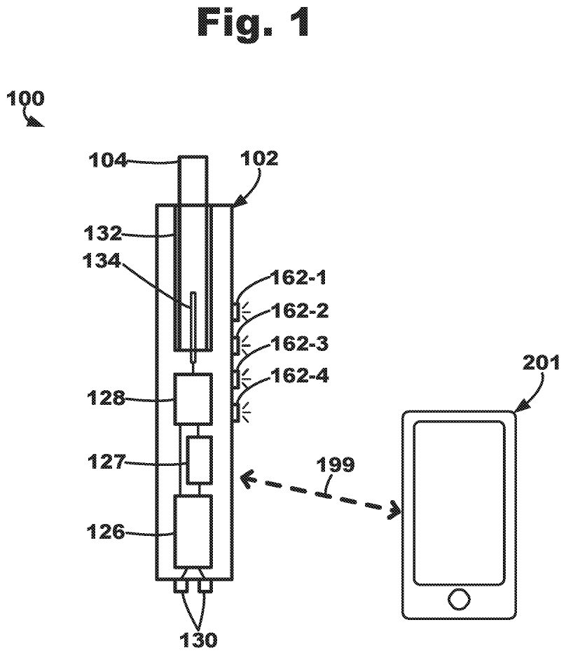

FIG. 1 is a schematic sectional view of an illustrative aerosol-generating apparatus 100 including an aerosol-generating device 102 and a user interface device 201 configured to interface with the aerosol-generating device 102.

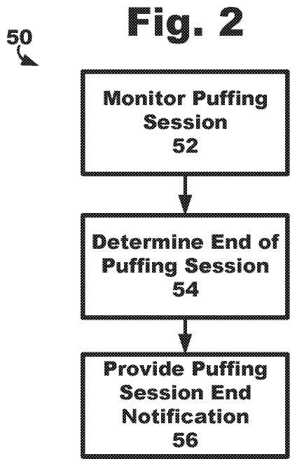

FIG. 2 is a block diagram of an illustrative method of generating a puffing session end notification of the aerosol-generating device 102.

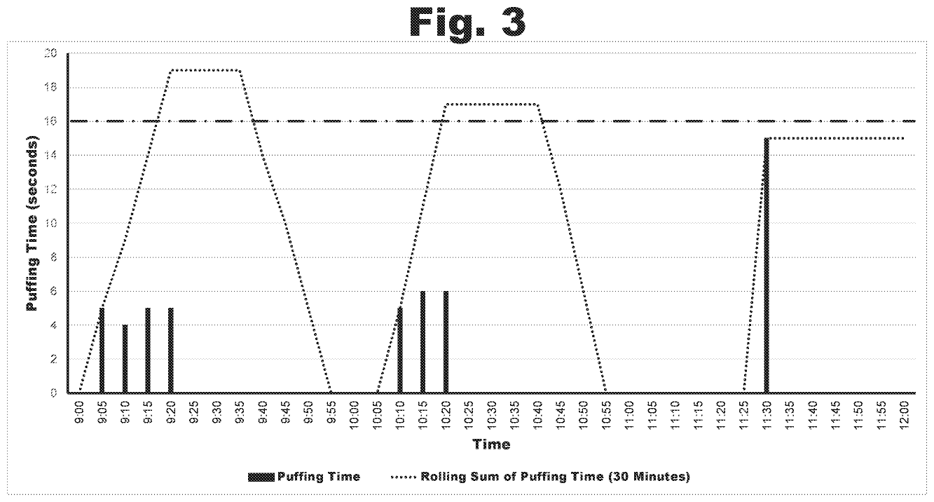

FIG. 3 is a graph of an illustrative puffing time over a portion of a day.

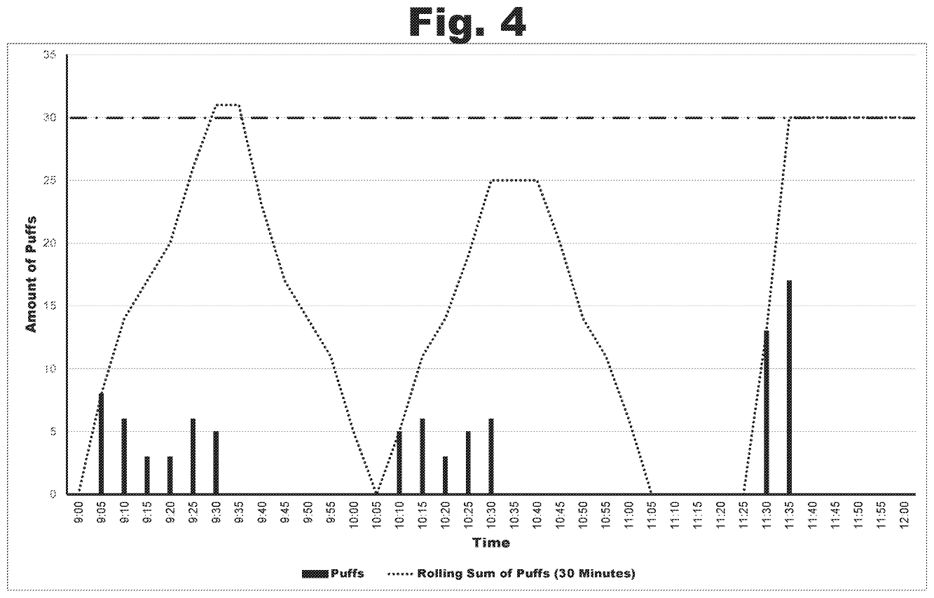

FIG. 4 is a graph of an illustrative number of puffs over a portion of a day.

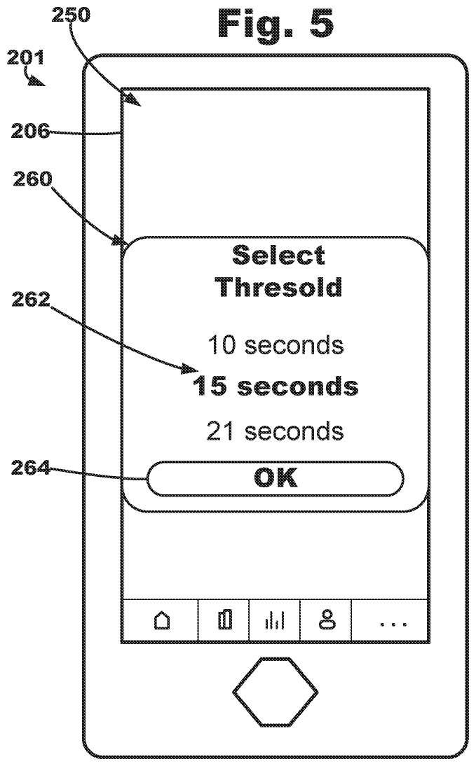

FIG. 5 is a schematic representation of an illustrative user interface device for use with changing a puffing time threshold of the aerosol-generating device 102.

An illustrative aerosol-generating apparatus 100 is depicted in FIG. 1. Preferably, the aerosol-generating apparatus 100 includes an aerosol-generating device 102 and a user interface device 201. The aerosol-generating device 102 comprises a cavity 132 for receiving a second type of aerosol-generating article such as a heat stick 104 and a heater 134, which is configured to provide a source of heat to the heat stick 104 thus producing inhalable aerosol. The aerosol-generating device 102 further includes a controller 128 comprising one or more processors and associated memory. The controller 128 may further include a communication interface such as, for example, a wireless communication interface to, for example, communicate 199 with the host device 101 and a user interface device 201 shown in FIG. 5. The communication interface of the controller 128 may preferably comprise a BLUETOOH interface. The aerosol-generating device 102 further comprises a power supply 126 and power and data interface ports 130.

The controller 128 is configured to monitor the puffing by the user. In particular, the controller 128 is configured to monitor one or both of an amount of puffing time and a number of puffs over a moving, or rolling, time period. The aerosol-generating device 102 further includes puffing session indicator 127 operatively coupled to the controller 128 and power supply 126. The controller 128 in conjunction with the puffing session indicator 127 provide puffing session notification such as a puffing session end notifications to the user. The puffing session indicator 127 may include somatosensory apparatus such as a haptic or vibration-generating mechanism that is configured to delivery somatosensory sensations to the user when the controller 128 determines the end of the puffing session based the monitoring.

As shown, the aerosol-generating device 102 includes a plurality of indicators 162-1, 162-2, 162-3, 162-4 that may be used to convey information the user. For example, the plurality of indicators 162-1, 162-2, 162-3, 162-4 may be used to provide puffing session notifications such as puffing session end notifications to the user. In particular, for instance, the plurality of indicators 162-1, 162-2, 162-3, 162-4 may depict a light pattern indicative of end of a puffing session.

An illustrative method 50 of generating a puffing session end notification of the aerosol-generating device 102 is depicted in FIG. 2. The method 50 includes monitoring a puffing session of a user using the aerosol-generating device 52, determining an end of the puffing session based the monitoring 54, and providing a puffing session end notification to the user indicative of the end of the puffing session in response to determination of the end of the puffing session 56.

Illustrative puffing time over a portion of a day is depicted in the graph of FIG. 3. The portion of the day depicted is from 9:00 to 12:00. As shown, a user consumed, or inhaled, for seconds between 9:00 and 9:05 resulting in 5 seconds of puffing time as shown by the black bar extending upwardly from the x-axis at 9:05. Further, as can be seen, the user consumed 4 seconds of puffing time between 9:05 and 9:10, 5 seconds of puffing time between 9:10 and 9:15, and 5 seconds of puffing time between 9:15 and 9:20.

A rolling sum of puffing time over a moving time window of 30 minutes is depicted as the dotted line on the graph. Further, a puffing time threshold of 16 seconds is depicted using the dash-dot line. As can be seen, the amount of puffing time over the moving window of 30 minutes is exceeded between 9:15 and 9:20. Thus, the illustrative devices, methods, and computer products described herein may determine an end of the puffing session based on such monitoring, and may then provide a puffing session end notification to the user indicative of the end of the puffing session.

Further, the user again exceeds the puffing time threshold again between 10:15 and from puffing for 5 seconds between 10:05 and 10:10, puffing for 6 seconds between and 10:15, and puffing for 6 seconds between 10:15 and 10:20, which would result in a puffing session end notification being delivered to the user indicative of the end of the puffing session. Finally, the user does not exceed the puffing time threshold when puffing for seconds between 11:25 and 11:30, which would not result in the delivery of a puffing session end notification.

Illustrative number of puffs over a portion of a day is depicted in the graph of FIG. 4. The portion of the day depicted is from 9:00 to 12:00. As shown, a user puffs 8 times between 9:00 and 9:05 as shown by the black bar extending upwardly from the x-axis at 9:05. Further, as can be seen, the user puffed 6 times between 9:05 and 9:10, puffed 3 times between 9:10 and 9:15, puffed 3 times between 9:15 and 9:20, puffed 6 times between 9:20 and 9:25, and puffed 5 times between 9:25 and 9:30.

A rolling sum of puffs over a moving time window of 30 minutes is depicted as the dotted line on the graph. Further, a puffing number threshold of 30 is depicted using the dash-dot line. As can been seen, the number of puffs over the moving window of 30 minutes is exceeded between 9:25 and 9:30. Thus, the illustrative devices, methods, and computer products described herein may determine an end of the puffing session based on such monitoring, and may then provide a puffing session end notification to the user indicative of the end of the puffing session.

Further, the user does not exceeds the puffing number threshold when puffing 5 times between 10:05 and 10:10, puffing 6 times between 10:10 and 10:15, puffing 3 times between and 10:20, puffing 5 times between 10:20 and 10:25, and puffing 6 times between and 10:30, which would not result in the delivery of a puffing session end notification. Finally, the user does again exceed the puffing time threshold again when puffing 13 times between 11:25 and 11:30 and puffing 17 times between 11:30 and 11:35, which would result in a puffing session end notification being delivered to the user indicative of the end of the puffing session.

An illustrative user interface device 201 including a display 206 depicting a graphical user interface 250 is shown in FIG. 5. The graphical user interface 250 includes a graphical region 260 for the selection of a puffing time threshold. For example, a user may select a puffing time threshold from a rotating selector graphic 262 located within the graphical region 260, and once the puffing time threshold is selected, the user may select an “OK” confirmation graphical area 264. After the puffing time threshold is selected and confirmed, the user interface device 201 wirelessly transmits the updated puffing time threshold to the aerosol-generating device 102.

All scientific and technical terms used herein have meanings commonly used in the art unless otherwise specified. The definitions provided herein are to facilitate understanding of certain terms used frequently herein. As used herein, the singular forms “a”, “an”, and “the” encompass embodiments having plural referents, unless the content clearly dictates otherwise. As used herein, “or” is generally employed in its sense including “and/or” unless the content clearly dictates otherwise. The term “and/or” means one or all of the listed elements or a combination of any two or more of the listed elements. As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like. The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±1% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-2. (canceled)

3. An aerosol-generating device comprising:
a puffing session indicator; and
a controller comprising one or more processors and operably coupled to the puffing session indicator, the controller configured to:
monitor a puffing session of a user comprising monitoring an amount of puffing time or a number of puffs over a moving time window;
determine an end of the puffing session based the monitoring; and
provide a puffing session end notification to the user indicative of the end of the puffing session in response to determination of the end of the puffing session.

4. The aerosol-generating device of claim 3, wherein determining the end of the puffing session based the monitoring comprises determining the end of the puffing session when the amount of puffing time exceeds a puffing time threshold during the moving time window.

5. The aerosol-generating device of claim 4, wherein the controller further configured to execute:
allowing the user to select the puffing time threshold.

6. The aerosol-generating device of claim 3, wherein determining the end of the puffing session based the monitoring comprises determining the end of the puffing session when the number of puffs exceeds a puff number threshold during the moving time window.

7. The aerosol-generating device of claim 6, wherein the controller further configured to execute:
allowing the user to select the puff number threshold.

8. The aerosol-generating device of claim 3, wherein the moving time window is 30 minutes.

9. The aerosol-generating device of claim 5, wherein allowing the user to select comprises allowing the user to use a user interface device to select.

10. The aerosol-generating device apparatus as in of claim 9, wherein the user interface device is a cellular telephone.

11. The aerosol-generating device of claim 3, wherein the puffing session end notification comprises a somatosensory output to the user.

12. The aerosol-generating device of claim 11, wherein the somatosensory output comprises a vibration.

13. The aerosol-generating device of claim 3, wherein the puffing session end notification comprises turning off the aerosol-generating device.

14. A method for use with an aerosol-generating device comprising:
monitoring a puffing session of a user using the aerosol-generating device comprising monitoring an amount of puffing time or a number of puffs over a moving time window;
determining an end of the puffing session based the monitoring; and
providing a puffing session end notification to the user indicative of the end of the puffing session in response to determination of the end of the puffing session.

15. The method of claim 14, wherein determining the end of the puffing session based the monitoring comprises determining the end of the puffing session when the amount of puffing time exceeds a puffing time threshold during the moving time window.

16. The method of claim 15, wherein the method further comprises allowing the user to select the puffing time threshold.

17. The method of claim 16, wherein allowing the user to select the puffing time threshold comprises allowing the user to select the puffing time threshold using a user interface device.

18. The method of claim 14, wherein determining the end of the puffing session based the monitoring comprises determining the end of the puffing session when the number of puffs exceeds a puff number threshold during the moving time window.

19. The method of claim 17, wherein the method further comprises allowing the user to select the puff number threshold.

20. The method of claim 14, wherein the moving time window is 30 minutes.

21. The method of claim 14, wherein the puffing session end notification comprises a somatosensory output to the user.

22. The method of claim 14, wherein the puffing session end notification comprises turning off the aerosol-generating device.

23. Computer program product for use with aerosol-generating device comprising a non-transitory computer readable medium having program code stored thereon, the program code configured, when said program product is run on a computer, to:
monitor a puffing session of a user using the aerosol-generating device comprising monitoring an amount of puffing time or a number of puffs over a moving time window;
determine an end of the puffing session based the monitoring; and
provide a puffing session end notification to the user indicative of the end of the puffing session in response to determination of the end of the puffing session.
